(19) United States
(12) Patent Application Publication
(10) Pub. No.: US 2015/0023390 A1
(43) Pub. Date: Jan. 22, 2015

(54) TEMPERATURE TEST UNIT WITH PROCESSOR

(71) Applicant: Henry C. CHU, (US)

(72) Inventor: Henry C. CHU, Orange, CA (US)

(21) Appl. No.: 13/945,958

(22) Filed: Jul. 19, 2013

(51) Int. Cl. G01K 1/02

(52) U.S. Cl. CPC G01K 1/028
USPC 374/170

(57) ABSTRACT

A temperature test unit includes two thermometers each having a probe for detecting a temperature at a heat exchanging system, a processing mechanism electrically connected to the thermometers for receiving and processing the temperature readouts, and for obtaining a temperature difference between the temperature readouts, and a displayer device electrically connected to the processing mechanism and having two portions for displaying the temperature readouts of the thermometers, and another portion for displaying the temperature difference between the temperature readouts of the thermometers and for allowing the user to diagnose the problem in the heat exchanging system correctly and instantly.

### BACKGROUND OF THE INVENTION

1. Field of the Invention

The present invention relates to a temperature test unit, and more particularly to a temperature test unit including dual digital temperature gauges or thermometers with a processing mechanism which receives and processes the temperature readouts from the digital temperature gauges or thermometers in order to send out the temperature degree differential between the two digital temperature gauges or thermometers instantly and so as to diagnosis the problem in the heat exchanging system correctly.

2. Description of the Prior Art

Typical automatic transmission cooling systems comprise an integrated arrangement for heat exchange relation with various auxiliary heat loads in a combustion engine system, a coolant is circulated by the pump from the engine and the various auxiliary heat loads to a single dissipation heat exchanger for dissipation of the absorbed heat energy. The cooling system is designed for maintenance of the engine and the auxiliary heat loads at individually selected operating temperature levels.

It is common for vehicles with automatic transmissions to have a cooling system for the transmission fluid in order to keep the operating temperature of the transmission within a desired range. The transmission fluid is used to lubricate and cool automatic transmissions such as those used in internal combustion engines in vehicles, the high operating temperatures of automatic transmissions causes heat to be absorbed by the transmission fluid which must be removed to obtain the optimum lubrication performance of the transmission fluid.

Typically, an air to oil heat exchanger or an oil to coolant water heat exchanger receives a coolant inlet line or conduit from the transmission and has an outlet conduit connected to the transmission to circulate transmission fluid between the transmission and the cooler to remove heat from the lubrication fluid.

Thus, in a transmission cooling system, transmission fluid is circulated from the vehicle's transmission system, through a transmission fluid cooler which controls the temperature of the transmission fluid, and returns to circulate through the transmission, thereby keeping the transmission within desired operating temperature range.

However, when a vehicle's automatic transmission fails, fine metal particles are released into the circulating transmission fluid and become trapped in the transmission cooling system's cooler, usually within the fine metal weave. These metallic particles must be flushed from the transmission cooling system before a repaired or replacement transmission is installed, lest the particles circulate back into the new transmission with the new transmission's cooling fluid, thereby contaminating the new transmission and causing it to fail within a short period of time. It is therefore desirable to have an apparatus for diagnosing and flushing a vehicle's automatic transmission cooling system.

For example, U.S. Pat. No. 4,362,131 to Mason et al., U.S. Pat. No. 5,385,613 to Coleman, U.S. Pat. No. 5,392,796 to Coleman, U.S. Pat. No. 6,412,341 to Ballew, and U.S. Pat. No. 6,539,958 to Betancourt et al. disclose several of the typical vehicles with automatic transmissions to have a cooling system for removing heat from the lubrication fluid.

However, normally, the worker or the user may know only the temperature readouts at the coolant inlet line or conduit and at the coolant outlet line or conduit respectively, and it takes time to calculate the temperature degree differential between the two temperature readouts, and the worker or the user may not know and obtain the temperature degree differential between the two temperature readouts instantly such that the worker or the user may not diagnosis the problem in the heat exchanging system correctly and instantly.

The present invention has arisen to mitigate and/or obviate the afore-described disadvantages of the conventional temperature test mechanisms.

### SUMMARY OF THE INVENTION

The primary objective of the present invention is to provide a temperature test unit including dual digital temperature gauges or thermometers with a processing mechanism which receives and processes the temperature readouts from the digital temperature gauges or thermometers in order to send out the temperature degree differential between the two digital temperature gauges or thermometers instantly and so as to diagnosis the problem in the heat exchanging system correctly.

In accordance with one aspect of the invention, there is provided a temperature test unit comprising a first thermometer and a second thermometer each including a probe for detecting a temperature at a heat exchanging system, a processing mechanism electrically connected to the first and the second thermometers for receiving and obtaining temperature readouts from the first and the second thermometers respectively and for processing the temperature readouts, and for obtaining a temperature difference between the temperature readouts, and a displayer device electrically connected to the processing mechanism and including a first portion for displaying the temperature readout of the first thermometer, a second portion for displaying the temperature readout of the second thermometer, and a third portion for displaying the temperature difference between the temperature readouts of the first and the second thermometers and for allowing the user to know or realize and obtain the temperature degree difference between the two temperature readouts instantly such that the worker or the user may diagnose the problem in the heat exchanging system 80 correctly and instantly.

The displayer device may be selected from a digital displayer device or the like for showing or displaying the digital temperature readouts and the temperature difference between the readouts.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a temperature test unit in accordance with the present invention; and

FIG. 2 is another plan schematic view of a handheld device of the temperature test unit, illustrating the operation of the temperature test unit.

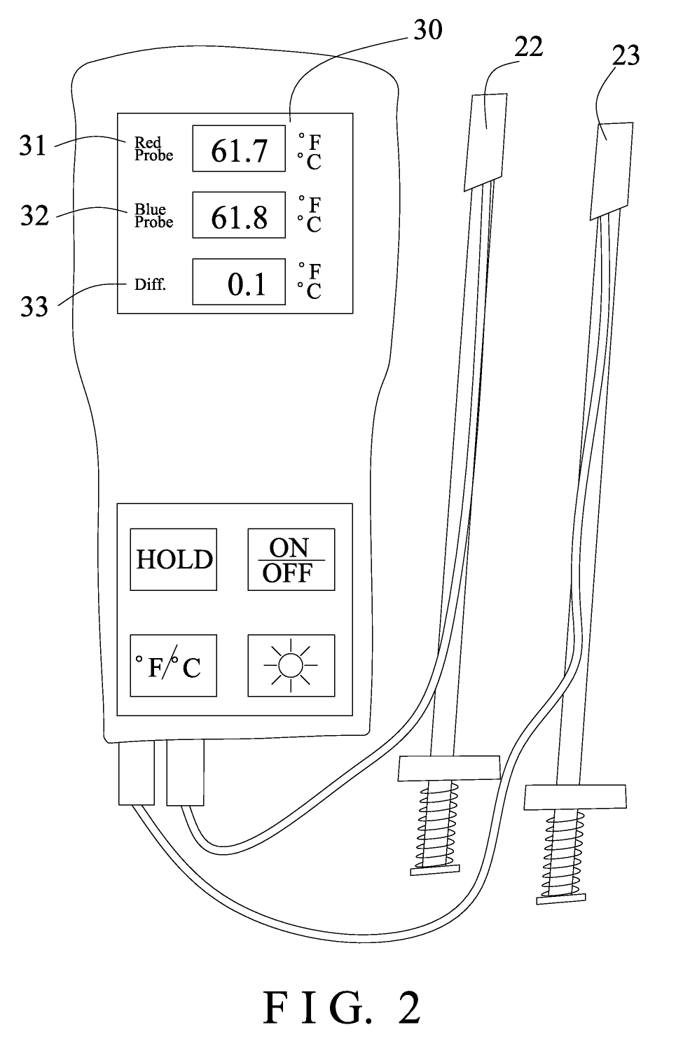

### DETAILED DESCRIPTION OF THE PREFERRED EMBODIMENT

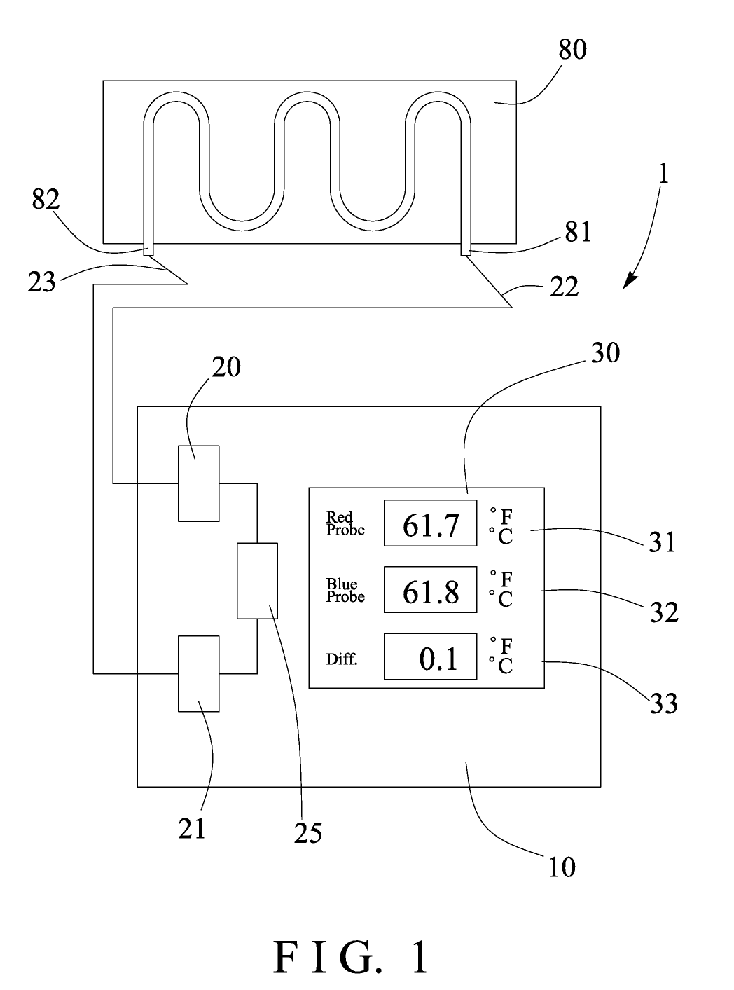

Referring to the drawings, and initially to FIG. 1, a temperature test unit 1 in accordance with the present invention comprises an outer container or housing or receptacle 10, two temperature gauges or thermometers 20, 21 disposed or attached or mounted or secured or engaged in the receptacle 10, and two pick up probes 22, 23 electrically connected or coupled to the thermometers 20, 21 respectively for connecting or coupling to or engaging with the coolant inlet line or conduit 81 and the coolant outlet line or conduit 82 of a heat exchanger or heat exchanging system 80 respectively and for sensing or detecting the temperatures at the coolant inlet conduit 81 and the coolant outlet conduit 82 of the heat exchanging system 80 respectively.

The temperature test unit 1 further comprises a calculator or processer device or processing mechanism 25 electrically connected or coupled to the thermometers 20, 21 respectively for receiving or obtaining the temperature readouts from the thermometers 20, 21 and/or from the coolant inlet and outlet conduits 81, 82 of the heat exchanging system 80 respectively and for calculating or treating or processing the temperature readouts into digital temperature readouts; and further comprises a displayer device 30, such as a digital displayer device 30 electrically connected or coupled to the processing mechanism 25 for showing or displaying the digital temperature readouts or the thermometers 20, 21 and the temperature difference between the two digital temperature readouts.

For example, the displayer device 30 includes a first part or portion or screen 31 for showing or displaying the digital temperature readout of one of the thermometers 20, a second part or portion or screen 32 for showing or displaying the digital temperature readout of the other thermometer 21, and a third part or portion or screen 33 for sending out or showing or displaying the digital temperature difference between the two digital temperature readouts of the thermometers 20, 21, and for allowing the user to know or realize and obtain the temperature degree difference between the two temperature readouts instantly such that the worker or the user may diagnose the problem in the heat exchanging system 80 correctly and instantly.

It is to be noted that the temperature readings at the coolant inlet and outlet conduits 81, 82 of the heat exchanging system 80 and/or of the thermometers 20, 21 may be changed rapidly or quickly, and it is almost impossible to know or realize and obtain the temperature degree difference between the two temperature readouts without a calculator or processer device or processing mechanism 25, and it is very important that the worker or the user to know or realize and obtain the temperature degree difference between the two temperature readouts instantly in order to diagnose the problem in the heat exchanging system 80 correctly and instantly.

When the cooling effect or operation or efficiency of the heat exchanger or heat exchanging system 80 is in good order, the instant temperature degree difference may provide and indicate that the heat exchanger or heat exchanging system 80 is in good order. On the contrary, when the heat exchanger or heat exchanging system 80 has some blockage or the like, the larger or greater temperature degree difference may provide and indicate that the heat exchanger or heat exchanging system 80 is not in good order, or is in a plug condition, and a flushing operation or replacement operation will be required for the worker or the user to repairing or replacing the heat exchanger or heat exchanging system 80. It is to be noted that the temperature test unit in accordance with the present invention may be widely used for diagnosing the transmission cooler, engine cooler, the exhaust muffler, the power steering system for automatic vehicles, and/or the CNC machine cooler etc.

Accordingly, the temperature test unit in accordance with the present invention includes dual digital temperature gauges or thermometers with a processing mechanism which receives and processes the temperature readouts from the digital temperature gauges or thermometers in order to send out the temperature degree differential between the two digital temperature gauges or thermometers instantly and so as to diagnosis the problem in the heat exchanging system correctly.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A temperature test unit comprising:
a first thermometer and a second thermometer each including a probe for detecting a temperature at a heat exchanging system,
a processing mechanism electrically connected to said first and said second thermometers for receiving and obtaining temperature readouts from said first and said second thermometers respectively and for processing said temperature readouts, and for obtaining a temperature difference between said temperature readouts, and
a displayer device electrically connected to said processing mechanism and including a first portion for displaying said temperature readout of said first thermometer, a second portion for displaying said temperature readout of said second thermometer, and a third portion for displaying said temperature difference between said temperature readouts of said first and said second thermometers.

2. The temperature test unit as claimed in claim 1, wherein said displayer device is a digital displayer device.
